(19) United States
(12) Patent Application Publication
(10) Pub. No.: US 2006/0180372 A1
(43) Pub. Date: Aug. 17, 2006

(54) Electronic stability system on a three-wheeled vehicle

(75) Inventors: Daniel Mercier, Magog (CA); Roland Jonasch, Westmount (CA)

Correspondence Address: OSLER, HOSKIN & HARCOURT LLP (BRP), 2100 - 1000 DE LA GAUCHETIERE ST. WEST, MONTREAL, H3B4W5, CA

(73) Assignee: Bombardier Recreational Products Inc., Valcourt (CA)

(21) Appl. No.: 10/920,226

(22) Filed: Aug. 18, 2004

Related U.S. Application Data
(60) Provisional application No. 60/496,905, filed on Aug. 22, 2003.
(60) Provisional application No. 60/547,089, filed on Feb. 25, 2004.
(60) Provisional application No. 60/547,092, filed on Feb. 25, 2004.

(51) Int. Cl. B62D 61/06; B60T 7/12; B60T 8/60

(52) U.S. Cl. 180/210; 701/83; 303/146

(57) ABSTRACT

A three-wheeled vehicle having a pair of front wheels and a single rear wheel is provided with an electronic stability system (ESS) to control certain operating parameters of the vehicle based on sensed inputs from the three wheels. Preferably, the three-wheeled vehicle has a straddle type seat, an internal combustion engine, and road tires suitable for conventional road use.

### CROSS REFERENCES

The present Utility patent application claims priority on U.S. Provisional Application 60/496,905 filed Aug. 22, 2003, titled “Stability control system for a three-wheeled vehicle”, 60/547,092, titled “Stability control system for a recumbent three-wheeled vehicle” and 60/547,089, titled “Stability control system for a three-wheeled vehicle”, both filed on Feb. 25, 2004. The content of these three provisional applications are incorporated herein by reference in the present Utility patent application.

U.S. Utility Pat. Nos. 6,263,261, 6,324,446, 6,086,168, 6,409,286, 6,338,012 and U.S. Patent Application Publications Nos. 2003/0158641 and 2003/0093190 are incorporated herein by reference in the present Utility patent application. In addition, the text found at http://www.rqriley.com/3-wheel.html is also incorporated herein by reference and a copy is appended hereto for convenience.

### FIELD OF THE INVENTION

The present invention relates to vehicles with stability control systems, especially electronic stability control systems that improve driving stability of the vehicle. In particular, the invention relates to a three-wheeled vehicle having a stability control system.

### BACKGROUND OF THE INVENTION

Motorized three-wheeled vehicles are well known in the art. Such vehicles are typically off road type or all terrain vehicles (also known as “ATVs”). Two different configurations of three-wheeled vehicles are generally known. The first configuration has two wheels at the front and one wheel at the back of the vehicle. The second configuration has one wheel at the front and two wheels at the back.

Regardless of the particular configuration for a three-wheeled vehicle, those skilled in the art recognize that three-wheeled vehicles are intrinsically less stable than four-wheeled vehicles, such as automobiles. Several factors contribute to this instability. For comparable wheelbase, wheeltrack and center of gravity (CG) position, the rollover axis of the three-wheeled vehicle are closer to the CG than they are for a four-wheeled vehicle.

It should be noted at the outset that the intrinsic instability of a three-wheeled vehicle versus a four-wheeled vehicle should not be understood to mean that a three-wheeled vehicle is unstable to the point that it is dangerous to a user. To the contrary, as would be understood by those skilled in the art, some designs for three-wheeled vehicles are inherently very stable and can even advantageously compared to some four-wheeled vehicle.

Another factor that affects the stability of a vehicle is the center of gravity of the vehicle. The height of the center of gravity of a vehicle is measured as a distance from the ground when the vehicle is at rest. The center of gravity changes based on the rider position and the type of seating arrangement provided.

A straddle seat type vehicle positions the rider higher from the ground and, as a result, typically creates a vehicle with a higher center of gravity than a vehicle that has a recumbent type seat, which may be more stable but requires additional space and have a different weight distribution since the rider cannot be superposed over the engine. Recumbent type seats include bucket seats, etc. of the type usually found in four-wheeled vehicles. Recumbent seat configurations generally position two riders side by side.

While straddle seats may alter disadvantageously the center of gravity of a vehicle, they offer certain advantages that are not available with recumbent seats. In particular, straddle seats allow a more compact riding position, allows a better vision since the driver is higher and permit the rider to lean into a turn for enhanced handling. Straddle seats also may provide a second passenger seat behind the driver seat, if desired, but the additional rider also tends to raises the center of gravity of the vehicle.

An advantage of a tandem straddle-type is that the center of gravity of the vehicle remains symmetrically positioned if there are one or more riders. In contrast, on a light weight recumbent three-wheeler, when only the driver is present, the center of gravity is not located in the same position as when there are two riders in the vehicle. When only a driver is present in a three-wheeled vehicle with recumbent seats, the center of gravity will be offset from the longitudinal centerline of the vehicle in a direction toward the driver. As would be appreciated by those skilled in the art, this offset may have an affect on the handling performance of the recumbent-seated vehicle.

Other factors that affect stability include the distance between the tires. On a vehicle, the wheel base refers to the distance between the front tires and the rear tire(s). The wheel track, on the other hand, refers to the distance between two tires on the same axle; in this particular case the two front tires, which is typically very similar to the distance between the rear tires in a four wheeled vehicle. A larger distance between the tires (whether it be the wheel base or the wheel track) enhances the stability of the vehicle, but creates a larger vehicle, in terms of over all length and width, that may be less maneuverable because of the vehicle's increased size.

When operating any vehicle, especially a three-wheeled vehicle, stability is a concern during turning. When negotiating a curve, a vehicle is subject to centrifugal forces, as is readily understood by those of ordinary skill in the art of vehicle design. Generally, a higher center of gravity causes the vehicle to have a lower rollover threshold to centrifugal forces than a vehicle with a lower center of gravity.

Three-wheeled vehicles raise special stability concerns since there is a smaller total tire contact area (with the ground) as compared with a similar size four-wheeled vehicles. Usually three-wheeled vehicles have a smaller mass therefore they are more affected by variation of loading, particularly driver, passenger and cargo weight. Moreover, if a straddle seat is employed, the center of gravity can be relatively high as compared with that of a recumbent three-wheeled vehicle.

To equip a three-wheeled vehicle for road use, road tires must be employed. In a poorly designed vehicle, at high speeds or in sharp turns, the centrifugal forces generated on a road could exceed the traction threshold of a road tire, which could cause one or more of the tires to slip on the road surface. The slippage may be so severe that the vehicle could oversteer or understeer under certain circumstances.

As would be appreciated by those skilled in the art, modern road tires can offer considerable grip on a road surface. The gripping force of modern road tires can be so strong, in fact, that a vehicle with a high center of gravity may be subjected to forces that may cause the vehicle to exceed its rollover threshold. If the rollover threshold is exceeded, one or more of the vehicle's wheels on the inner side of the curve may lift off of the road surface. Under such circumstances, if the rider continues to apply a lateral acceleration to the vehicle, the rider may be able to roll the vehicle over. Tripped rollover can also be experienced under severe oversteering conditions if the tires suddenly recover traction with the ground or hit an obstacle side ways. As a result, electronic stability systems (ESS) have been developed to improve the stability of such vehicles.

Electronic Stability Systems (ESS) or Vehicle Stability Systems (VSS) are designed to electronically manage different systems on an automotive vehicle to influence and control the vehicle's behavior. An ESS can manage a considerable number of parameters at the same time. This provides an advantage over an automotive vehicle merely operated by a person since the driver can only manage a limited number of parameters at the same time. A typical ESS takes several inputs from the vehicle and applies different outputs to the vehicle to influence the vehicle's behavior. Examples of inputs include steering column rotation, the longitudinal and transverse acceleration of the vehicle, the engine output, the detection of the presence (or absence) of a rider and a passenger, the speed of the four wheels and the brake pressure in the wheel's brakes. Traditional ESS's use inputs from all four wheels. Some low-cost systems use reduced inputs, but this does not result in optimal behavior interpretation. Inputs from suspension displacement and brake and accelerator pedal displacement can also be provided to the ESS.

The outputs from the ESS affect the automobile's behavior by generally independently managing the brakes on each wheel, the suspension, and the power output of the engine in order to improve the automobile's handling under certain circumstances. Since ESS's have been specifically developed for four-wheeled vehicles and rely on inputs provided by a four-wheeled vehicle, it is expensive and time consuming to adapt this kind of system to a three-wheeled vehicle. This is especially true since an ESS typically uses inputs from each of the four wheels independently and uses the braking system independently on all of the wheels. It is also possible to adapt suspension settings corresponding to the four wheels to change the behavior of the vehicle.

As would be appreciated by those skilled in the art, there are many ways in Which suspension behaviors can be modified. For example, the internal valve setting(s) in one or more of the shock absorbers may be changed mechanically or electronically. Alternatively, the spring pre-load may be adjusted. Additionally, the fluid viscosity in the shock absorber may be adjusted by subjecting a magnetorheological fluid to an external electric or magnetic field.

A three-wheeled vehicle configured with a single wheel at the rear of the vehicle does not provide all the information/data input required by a four-wheeled vehicle ESS. For example, there is only one rear wheel from which the ESS can receive input on speed. Moreover, on a vehicle having two rear wheels, when the brake is applied to one wheel, a “yaw moment” is generated about a vertical axis passing through the center of gravity of the vehicle. On a vehicle having only one rear wheel, the rear wheel is positioned in the same plane as the longitudinal axis of the vehicle, which makes it difficult to generate any “yaw moment” by applying the brake to the rear wheel. However, it is known that a very wide single rear tire can generate a small “yaw moment” under strong lateral acceleration due to lateral displacement of the tire contact patch. A vehicle experiencing understeer has limited cornering ability relative to the rear axle. In order to create a stabilizing yaw moment, a single brake force must be applied to an inner rear wheel, since this will create a restoring moment by capitalizing on the surplus cornering force available from that tire. It is understandable that this may cause a problem when there is only one centered rear wheel.

A system that controls stability of a three-wheeled vehicle is desired in the industry. There is especially a need for such a system that can operate based on inputs from a single rear wheel.

### SUMMARY OF THE INVENTION

One aspect of an embodiment of the present invention applies an ESS to a three-wheeled vehicle.

Another aspect of an embodiment of the present invention is to adapt an ESS for a four-wheeled vehicle to a three-wheeled vehicle. The ESS would receive and operate on input from only three wheels instead of four wheels.

One other aspect of the present invention provides an anti-roll over torque 128a applied on the roll over axis 112 opposite to the natural roll over torque generated by the centrifugal forces on the vehicle when the vehicle is cornering. This anti-roll over torque is automatically or semi-automatically generated by an electronic system.

Another aspect of the present invention applies an anti-roll over torque 128a to the vehicle without action in that respect from the driver or the passenger.

An additional aspect of the present invention evaluates the speed of a vehicle using only one rear wheel.

An aspect of an embodiment of the present invention uses the engine torque for vehicle speed calculation.

Another aspect of an embodiment of the present invention provides a traction control device that uses engine torque reduction and/or rear brake actuation.

Another aspect of an embodiment of the present invention reduces understeering by braking the rear wheel, or using engine torque reduction, to reduce the speed without generating any significant yaw moment on the vehicle.

One other aspect of an embodiment of the present invention uses the ESS to adjust and/or modify the engine's operating parameters like the RPM, engine torque, the throttle body opening, the ignition timing and the fuel/air ratio. The engine's parameters can be modified either electronically or mechanically, or by any other suitable controller.

A further aspect of the present invention prevents a three-wheeled vehicle from oversteering by managing the vehicle's behavior using an ESS. The ESS in accordance with this invention maintains the correct vehicle yaw rate when the three-wheeled vehicle is subject to lateral acceleration.

An aspect of the present invention provides the speed input to the ESS by using a global positioning system (or “GPS”). It is also considered using many points on the vehicle and the rider to determine the position and the direction of both the vehicle and the rider.

A further aspect of the present invention provides a sensor, in the form of a fourth “wheel” disposed on the three-wheeled vehicle that contacts the ground. The fourth “wheel” does not support the vehicle. Instead, it is used for determining the speed of the vehicle and may provide a speed input to the ESS.

Another aspect of the invention provides the speed information to the ESS using a photo optical system to evaluate the relative speed of the three-wheeled vehicle with the ground. The photo optical system can use any wave length of the spectrum to generate the photo optical signal.

An additional aspect of the present invention provides an ESS that allows one of the front wheels on a three-wheeled vehicle to lift from the ground during acceleration and cornering. The ESS in accordance with the invention tolerates a limited front wheel lift before re-establishing contact with the ground for all the wheels. Force sensors positioned at the shock mounts, among other areas, also may help to measure the CG distance and provide the ESS with another input that may be used for control.

Additional and/or alternative objects, features, aspects and advantages of the embodiments of the present invention will become apparent from the following description, the accompanying drawings and the appended claims.

### BRIEF DESCRIPTION OF THE DRAWINGS

For a better understanding of the present invention as well as other objects and further features thereof, reference is made to the following description which is to be used in conjunction with the accompanying drawings, where:

FIG. 1a is a rear perspective view of a straddle seat three-wheeled vehicle in accordance with an embodiment of the invention;

FIG. 1b is a front perspective view of a recumbent seat three-wheeled vehicle in accordance with an embodiment of the invention;

FIG. 2 is a schematic force diagram of a four-wheeled vehicle with a force applied to the front left wheel;

FIG. 3 is a schematic force diagram of a four-wheeled vehicle with a force applied to the right rear wheel;

FIG. 4 is a schematic force diagram of a four-wheeled vehicle with a force applied to the left rear wheel;

FIG. 5 is a schematic force diagram of a four-wheeled vehicle with a force applied to the front right wheel;

FIG. 6 is a schematic force diagram of a three-wheeled vehicle with a force applied to the front left wheel;

FIG. 7 is a schematic force diagram of a three-wheeled vehicle with a force applied to the front right wheel;

FIG. 8 is a schematic force diagram of a three-wheeled vehicle with a force applied to the single rear wheel;

FIG. 9a is a schematic view of one embodiment of a straddle seat three-wheeled vehicle showing the various sensors and components of the control system;

FIG. 9b is a schematic view of one embodiment of a recumbent seat three-wheeled vehicle showing the various sensors and components of the control system;

FIG. 10 is a block diagram of an ESS in accordance with the invention illustrated in FIGS. 9a and 9b;

FIG. 11a is a schematic diagram illustrating the effect of a braking force when applied to a three-wheeled vehicle;

FIG. 11b is a schematic diagram of a side view illustrating the torque generated by the braking force when applied to a three-wheeled vehicle;

FIG. 11c is a schematic diagram illustrating the effect of a braking torques when applied to a three-wheeled vehicle; and

FIG. 12 is a schematic diagram illustrating the effect of a braking force when applied to a four-wheeled vehicle.

### DESCRIPTION OF PREFERRED EMBODIMENT(S)

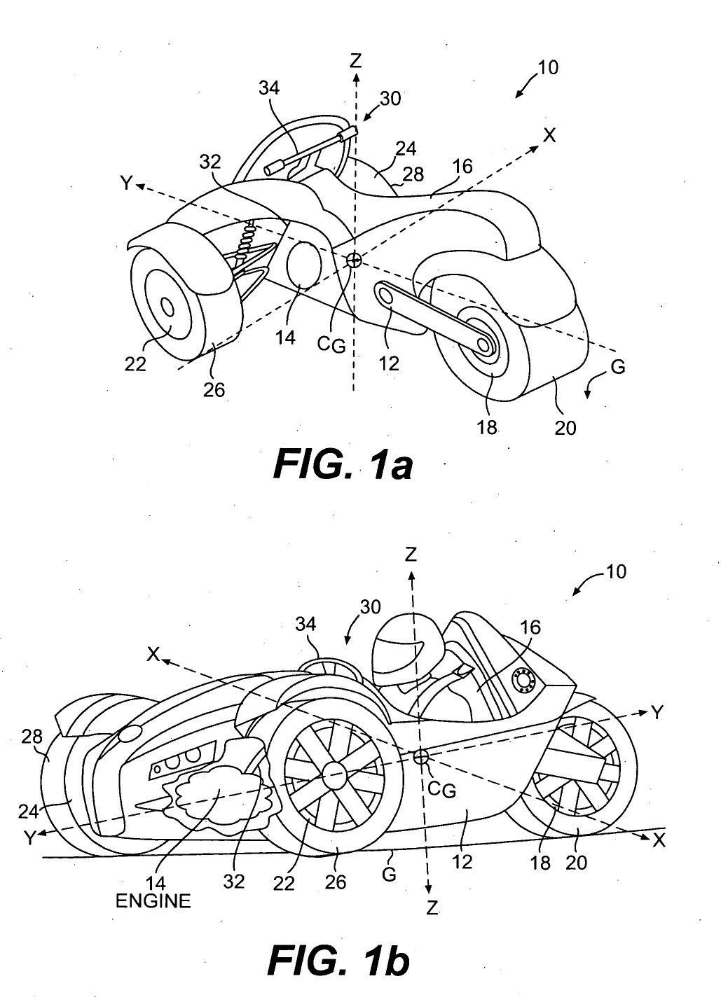

FIG. 1a illustrates a three-wheeled vehicle 10 in accordance with an embodiment of the invention. The particular design details of the three-wheeled vehicle 10 are not critical to this invention, and FIG. 1 merely illustrates one possible configuration. Vehicle 10 includes a frame 12 that supports an internal combustion engine 14, which could also be any type of power source including an electric motor if desired. A straddle seat 16 is mounted on the frame 12 and preferably has a driver seat portion and a passenger seat portion disposed behind the driver seat portion.

A single rear wheel 18 with a tire 20 suitable for road use is suspended from a rear-suspension system at the rear of the frame 12 and is connected operatively to the engine 14. A pair of front wheels 22 and 24 are suspended from the front of the frame 12. Each front wheel 22 and 24 has a road tire 26 and 28 mounted thereon. Each of the wheels are mounted with a suspension assembly that may include a damping mechanism such as a shock absorber.

A steering assembly 30 is coupled to the front wheels 22 and 24 and is supported by the frame 12 for transmitting steering commands to the front wheels 22 and 24. The steering assembly 30 can include a steering column 32 and a steering control mechanism 34, such as a handle bar, steering wheel, joystick or other known steering control mechanism.

FIG. 1b illustrates a recumbent, three-wheeled vehicle 10 in accordance with an embodiment of the invention. The particular design details of the three-wheeled vehicle 10 are not critical to this invention, and FIG. 1b merely illustrates one possible configuration. Vehicle 10 includes a frame 12 that supports an internal combustion engine 14, which could also be any type of power source including an electric motor or fuel cell, if desired. While the engine is shown at the front of the vehicle 10, those skilled in the art would readily recognize that the engine 14 may be located at any suitable position on the vehicle 10 without departing from the scope of the invention.

A recumbent, seat 16 is mounted on the frame 12. Preferably, the recumbent seat 16 has a driver seat portion and may also include a passenger seat portion disposed behind the driver seat portion. Alternatively, the recumbent seats 16 for the driver and passenger may be disposed side-by-side, as would be appreciated by those skilled in the art.

A single rear wheel 18 with a tire 20 suitable for road use is suspended from a rear suspension system at the rear of the frame 12 and is connected operatively to the engine 14. A pair of front wheels 22 and 24 are suspended from the front of the frame 12. Each front wheel 22 and 24 has a road tire 26 and 28 mounted thereon. Each of the wheels are mounted with a suspension assembly that may include a damping mechanism such as a shock absorber.

A steering assembly 30 is coupled to the front wheels 22 and 24 and is supported by the frame 12 for transmitting steering commands to the front wheels 22 and 24. The steering assembly 30 can include a steering column 32 and a steering control mechanism 34, such as a handle bar, steering wheel, joystick or other known steering control mechanism.

The vehicle 10 has a center of gravity CG that will change slightly when a rider is positioned in the vehicle 10, as is known. If the dry weight of the vehicle 10 is relatively low, the rider's weight may affect the height of the center of gravity of the vehicle, depending upon the distance from the recumbent seat 16 to the ground G. FIG. 1b illustrates the longitudinal axis y that extends the length of the vehicle, the transverse axis x that is generally perpendicular to the longitudinal axis y, and a vertical or yaw axis z, which is orthogonal to the two other axes. Each of the axes extends through the center of gravity C_{G}.

The vehicle 10 has a center of gravity C_{G} that will change slightly when a rider is positioned on the vehicle, as is known. If the dry weight of the vehicle is relatively low, the rider's weight will substantially affect the height of the center of gravity of the vehicle. FIGS. 1a and 1b illustrate the longitudinal axis y that extends the length of the vehicle, the transverse axis x that is generally perpendicular to the longitudinal axis y, and a vertical or yaw axis z, which is orthogonal to the two other axes. Each of the axes extend through the center of gravity C_{G}.

Satisfactory handling of a vehicle can be defined according to whether a vehicle maintains a path that accurately reflects the steering angle while remaining stable. A critical factor in assessing handling is the dynamic lateral response of the vehicle. This response is based on the vehicle's lateral motion, which is the float angle, and the tendency to rotate around the vertical axis z, which is the yaw rate. Controlling the yaw rate can reduce the float angle, thus improving control and handling of the vehicle.

A dynamic control system for a vehicle typically controls the yaw of the vehicle by controlling the braking effort at various wheels of the vehicle. Yaw control systems compare the desired direction of the vehicle based upon the steering wheel angle and the direction of travel of the vehicle. The desired direction of travel can be maintained by controlling, among other things, the amount of braking at each wheel. Such control, however, does not directly address the roll of the vehicle, which as noted above is a concern in vehicles having a high center of gravity. It also addresses rollover by preventing oversteer and spin out and promote a slight deceleration during rapid maneuvers thus reducing the risk of tipping. To minimize roll over tendencies, it is desirable to maintain contact between the tires and the ground.

A vehicle with rubber tires rotates at an angle relative to the ground to generate lateral guiding forces (cornering forces) between the wheel and the road surface. The angle is called the slip angle. Vehicles experience understeering when the front end's slip angle increases more rapidly than the rear slip angle as lateral acceleration rises. Higher rear slip is referred to as oversteer.

Cornering a vehicle generates centrifugal forces on the vehicle, which are a concern when the centrifugal forces climb beyond the lateral forces at the wheels and the vehicle's guided direction cannot be maintained. If the vehicle is going too fast at steady state when turning, the vehicle must be slowed down. Banked curves act as a positive counteractive influence against these forces. Electronic stability systems capitalize on this idea to apply graduated active braking to different wheels independently, to restore the vehicle to stable operation.

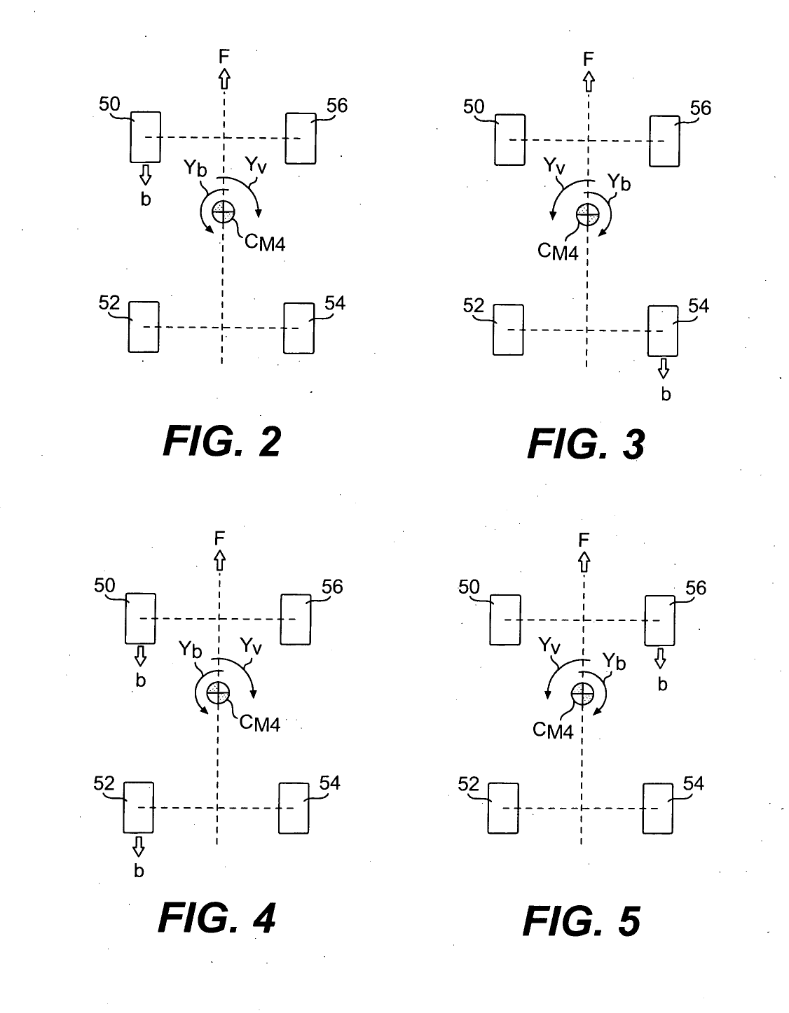

FIGS. 2-5 illustrate the typical forces experienced by a four-wheeled vehicle when forces are applied to each of the four tires. In FIG. 2, four tire footprints are illustrated: the front left tire footprint 50, the rear left tire footprint 52, the rear right tire footprint 54, and the front right tire footprint 56. The vehicle is oriented in a forward direction, indicated by arrow F, and has a center of gravity (or center of mass) Cₘ₄.

In FIG. 2, the vehicle is experiencing a yaw moment Yᵥ shown by the curved arrow about the Cₘ₄ in a clockwise direction. The vehicle's yaw moment Yᵥ is the result of all external forces acting on the vehicle and depending on the vehicle's understeer—or oversteer—behavior may result in a yaw rate that does not match the yaw rate demanded by the inputs to the steering mechanism, as would be appreciated by those skilled in the art. In case it doesn't match, to counteract the vehicle's yaw moment Yᵥ, a braking force is applied to the front left wheel that creates a force vector shown by arrow b. This establishes a braking yaw moment Y_{b}, that is opposite to the vehicle's yaw moment Yᵥ. FIG. 3 shows a counter clockwise vehicle yaw moment Yᵥ that is counteracted by a braking force applied to the right rear wheel creating a force vector b. As in FIG. 2, the braking force establishes a braking yaw moment Y_{b} that acts in a rotational direction opposite to the vehicle's yaw moment Yᵥ. FIG. 4 shows a clockwise vehicle yaw moment Yᵥ that is counteracted by a braking force applied to the left rear wheel creating a force vector b. The braking force b establishes a braking yaw moment Y_{b} that counteracts the vehicle's yaw moment Yᵥ. FIG. 5 shows a counter clockwise yaw moment Yᵥ that is counteracted by a braking force applied to the right front wheel creating a force vector b. The braking force b establishes a braking yaw moment Y_{b} that counteracts the vehicle's yaw moment Yᵥ.

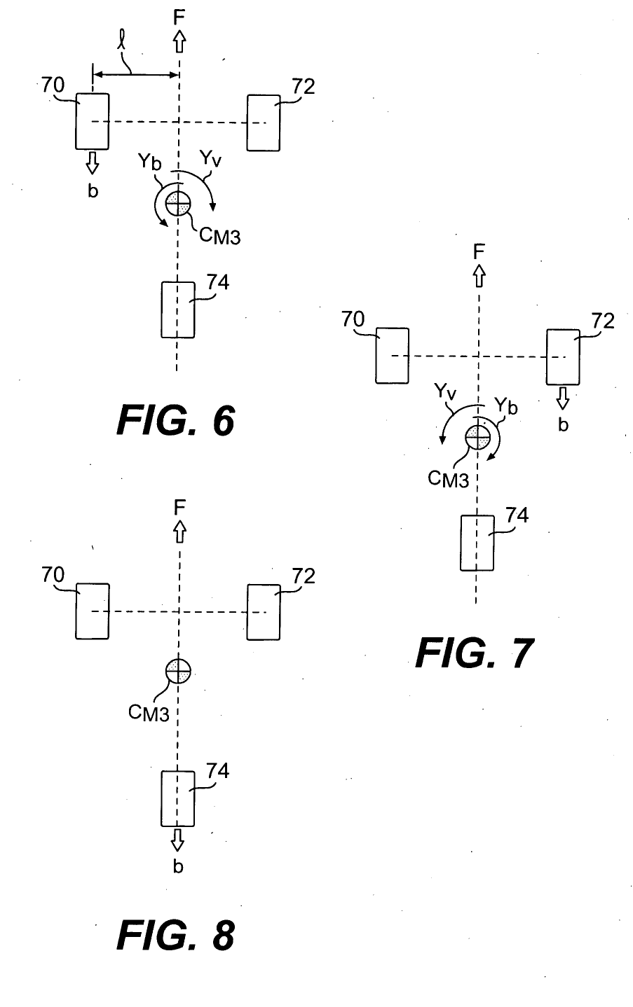

FIGS. 6-8 show a three-wheeled vehicle with front tire footprints 70 and 72 disposed on either side of the longitudinal axis at an equal distance/from the longitudinal axis and a single rear tire footprint 74 disposed on the longitudinal axis. As can be appreciated by FIG. 6, a clockwise yaw moment Yᵥ about the center of mass Cₘ₃ is counteracted by a braking force applied to the front left tire footprint 70 to create a force vector b. The braking force b establishes a braking yaw moment Y_{b} to counteract the vehicle's yaw moment Yᵥ. As illustrated in FIG. 7, a counter clockwise yaw moment Yᵥ is counteracted by a braking force applied to the front right tire footprint 72 to create a force vector b. The braking force b creates a braking yaw moment Y_{b} that counteracts the vehicle's yaw moment Yᵥ. As FIG. 8 illustrates, a braking force applied to the rear tire footprint 74, which creates a force vector b, does not generate a significant braking yaw moment in either clockwise or counter clockwise directions. However, as would be appreciated by those skilled in the art, if the vehicle is provided with a wide rear tire with a wide rear tire footprint 74, the force vector b may generate a comparatively small braking yaw movement Y_{b} of the type illustrated in FIGS. 6 and 7.

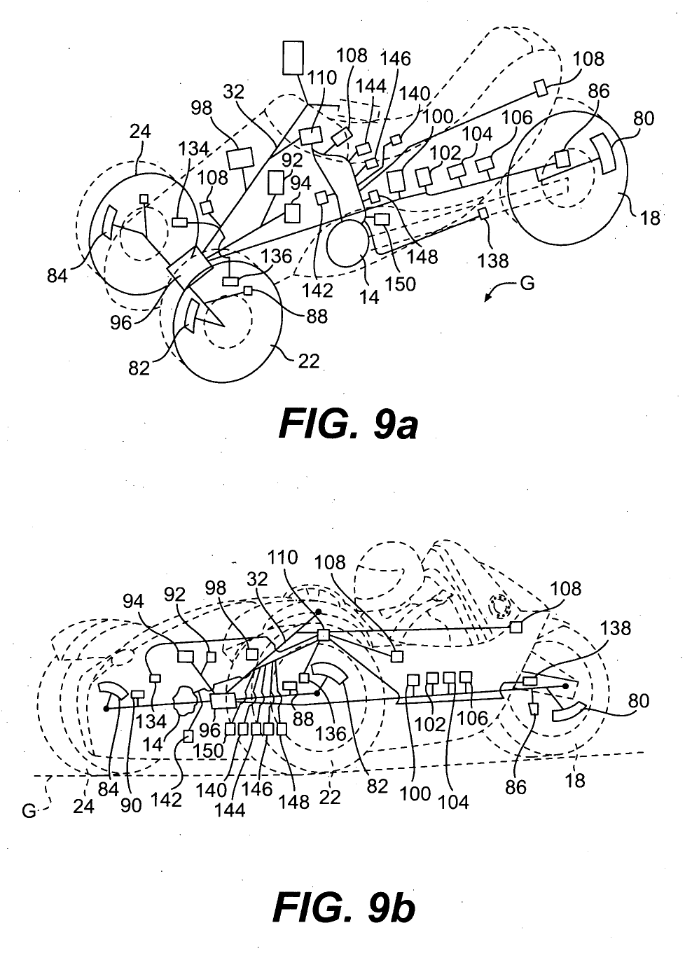

In this embodiment, the three-wheeled vehicle 10 is provided with the sensors described above. As seen schematically in FIG. 9, preferably the following components are present in the vehicle 10 and form a closed loop control system. Each wheel 18, 22, and 24 has a brake 80, 82, and 84, respectively, and at least one wheel speed sensor 86, 88, and 90, respectively. The wheel speed sensors 86, 88, 90 generate signals representative of the wheel rotation rates. One type of wheel speed sensor is an inductive wheel-speed sensor. Other types of sensors could be used, namely an active wheel-speed sensor or a Hall effect sensor.

In addition to the brakes 80, 82, and 84, the braking system can include a brake booster with a master cylinder 92, a primer pump 94 and a hydraulic modulator with a primary pressure sensor 96. The pressure sensor 96 can measure expansion rates and known methods of taking such measurements include strain gauges and variations in magnetic fields. These sensors are generally deployed with a hydraulic braking system. Preferably, the braking system is an antilock braking system (ABS).

A steering sensor 98 is connected to the steering assembly 32, and a yaw sensor 100 with a lateral acceleration sensor is mounted in the vehicle. The steering sensor 98, or encoder, generates signals representative steering angle—and angle variation rate—applied to the vehicle. The steering sensor 98 can be in the form of a contact wiper arrangement, such as a potentiometer, a contactless proximity sensor, such as a Hall IC, or an anisotropic magneto-resistive sensor. Yaw rotation moment can be indicative of skidding and traction loss. Yaw sensors 100 measure the rotation speed of the vehicle about the vertical axis and are typically gyrometers. Such sensors use secondary Coriolis forces developed within instationary systems. The yaw sensor 100 and acceleration sensor can be provided in the same casing.

A longitudinal acceleration sensor 102, a roll rate sensor 104 (or, alternatively, a roll angle sensor), and pitch rate sensor 106 are also provided. These could be individual devices or a package of sensing mechanisms. The acceleration sensors 102 can be based on inertial deflection. A Hall type sensor can provide a lateral-acceleration measurement. Throttle opening measurement 101, brake pressure measurement 103 and engine RPM are other possible inputs to be used by the system to determine the appropriate actions to be done for improving the vehicle's behavior.

A vehicle speed sensor 108 is also provided. The vehicle speed sensor 108 can be an optical type sensor that evaluates relative speed between the vehicle and the ground, a global positioning system (GPS) receiver, a rotatable sensor that runs over the ground like a non-load bearing wheel, or any other suitable type of speed sensor.

All of the components are electrically connected to an ECU 110. The precise location of the components can vary, and FIG. 9 merely shows one possible arrangement of the various sensors and components. The controller 110 may take any known form, including a microprocessor.

The ECU 110 is responsible for electrical, electronic and closed loop control functions, including power supply to system sensors, recording operating conditions, converting, manipulating, and transmitting data, and network linkage to other controllers if desired. The ECU 110 receives inputs from the various sensors and other vehicle operating systems, processes the input data, and outputs signals to actuate certain operating parameters of the vehicle. One parameter could be the braking system, in particular the hydraulic modulator and primer pump of the braking system. An hydraulic proportioning valve (not shown) could be installed to manage the pressure between the front wheels and the rear wheel. The proportioning valve could be electronically or mechanically managed to ensure proper pressure distribution.

In operation, the ECU 110 determines the vehicle's operating status based on the steering wheel angle, engine load factor(s) and operating data, such as road-speed. Lateral acceleration and yaw rate are determined to evaluate the actual status of the vehicle. Taking into account any detected control deviations, remedial action is defined and control parameters are calculated. Other factors are used in the calculation that are not immediately detectable, such as the tire coefficient of friction. The control system is monitored and modified accordingly. This is one example of a control scheme. Other factors and methods of calculating the control parameters and defining remedial action are contemplated.

One example of remedial action is to apply a braking force to counteract the yaw moment experienced by the vehicle. The location and amount of braking force is determined by readings from various sensors mounted on the vehicle. To affect braking, the hydraulic modulator 96 may be used to implement the ECU 110 commands. The modulator 96 regulates the pressure in the individual wheel brake cylinders via solenoid valves independent of braking pressure commands input by the driver.

To brake at selected individual wheels, without any driver input, the primer pump 94 can be used for “active” braking. The pump 94 provides a rapid response during active braking and may be directly linked to the brake fluid reservoir, with no intermediate valves to delay the response.

A charge piston assembly can be combined with the primer pump 94 to ensure rapid generation of adequate braking force. Since viscosity rises under cold conditions, which are also conditions that tend to trigger a control response, the pressurization of the wheel brake cylinders can be delayed. A charge piston assembly can press the brake pistons apart allowing the brake fluid to enter quickly in response to the primer pump 94.

The three wheels 18, 22, and 24 and the sensors described above that form the control system provide input to the ECU 110. An output is generated by the ECU 110 and provided to the braking system to generate a counteractive braking force. The precise algorithm implemented by the ECU 110 can vary, but is based on the parameters described above. One or more of the brakes may be activated by the ECU 110 to generate the counteractive braking force. The electronic control system 110 may also include a brake force distributing system that distributes the braking forces to each of the wheels 18, 22, and 24 to establish a sufficient braking yaw moment. In addition, the ECU 110 may be connected to the engine to control the power output of the engine 14 to enhance the braking yaw moment. The ECU 110 may control, for example, the throttle of the engine 14 to reduce the engine's power output therefore recovering lateral traction from the rear tire during oversteer condition. It can be appreciated by someone skilled in the art the ECU could control an engine revolution limiter, an ignition controller or a throttle controller.

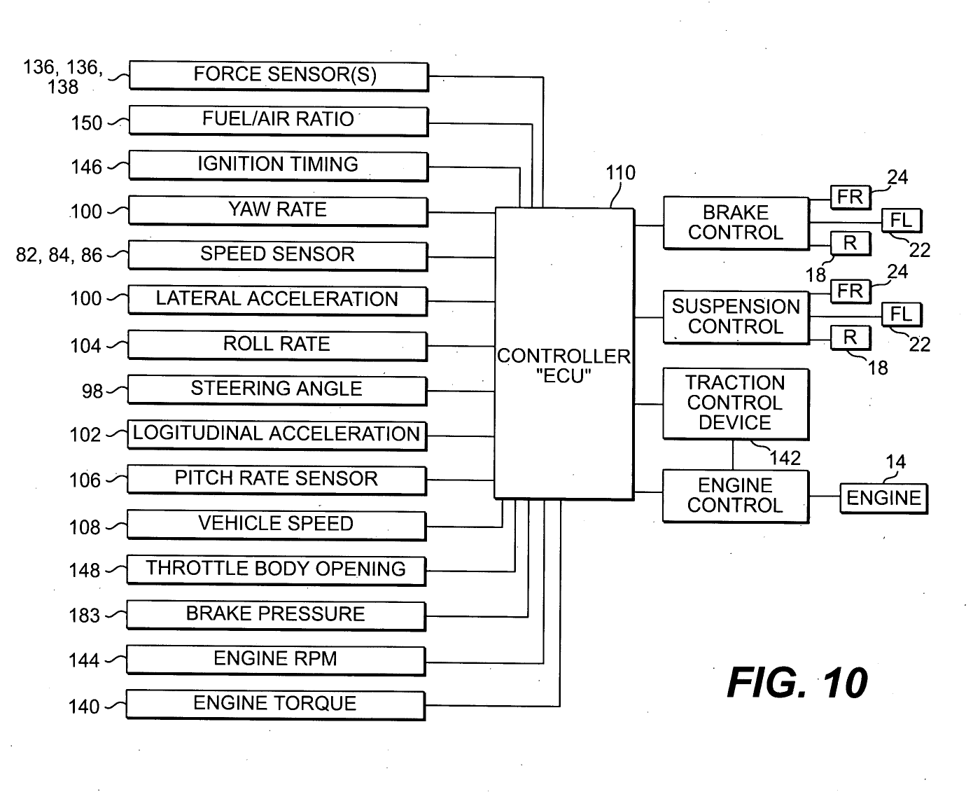

FIG. 10 shows a block diagram of the control system in accordance with one embodiment of the invention. In operation, the ECU 110 receives input relating to at least some of the following factors: the yaw rate from the yaw sensor 100, wheel speed from the speed sensors 82, 84, and 86, lateral acceleration also from the yaw sensor 100, roll rate determined from roll rate sensor 104, steering angle from the steering wheel sensor 98, longitudinal acceleration from sensing mechanism 102, and pitch rate from pitch rate sensor 106. Vehicle height sensors using either a mechanical displacement sensor or a photo-optical sensor also may be utilized to determine the distance between the vehicle and the ground. Alternatively, multiple photo-optical sensors may be placed on different parts of the vehicle to monitor the distance between particular parts of the vehicle and the ground, thereby providing comparative information about the tilt angle of the vehicle with respect to the ground (among other information).

These inputs are processed by the ECU 110 and various control schemes can be generated. To resist possible roll over, the braking system can be controlled, via an actuator, to apply a selective braking force to one or more of the wheels 18, 22, and/or 24. The braking actuator may be mechanically, hydraulically, electrically, or electronically controlled, for example. It is also possible to generate a scheme to control suspension that would apply a selective action to one or more of the suspension and/or damping elements related to the wheels 18, 22, and/or 24. It is further contemplated that an engine control scheme can be generated to affect power output of the engine 14 to control the vehicle 10. These control schemes can be used independently or in various combinations with each other.

As the three-wheeled vehicle 10 may be configured as a high performance vehicle, it may be desirable in certain situations to allow for limited lift of a front wheel 22 or 24 without engaging the vehicle control scheme. The ECU 110 can be programmed to allow a certain lift between the wheel and the road surface before engaging the control system. The program could be based on lifting distance, the period of time the lift occurs, vehicle speed, the intended course of the vehicle, among other considerations.

The significant element in this invention is that the control schemes are based on inputs from only three wheels and the control scheme is applied to stabilize the vehicle based on the three-wheeled configuration and its particular center of gravity parameters.

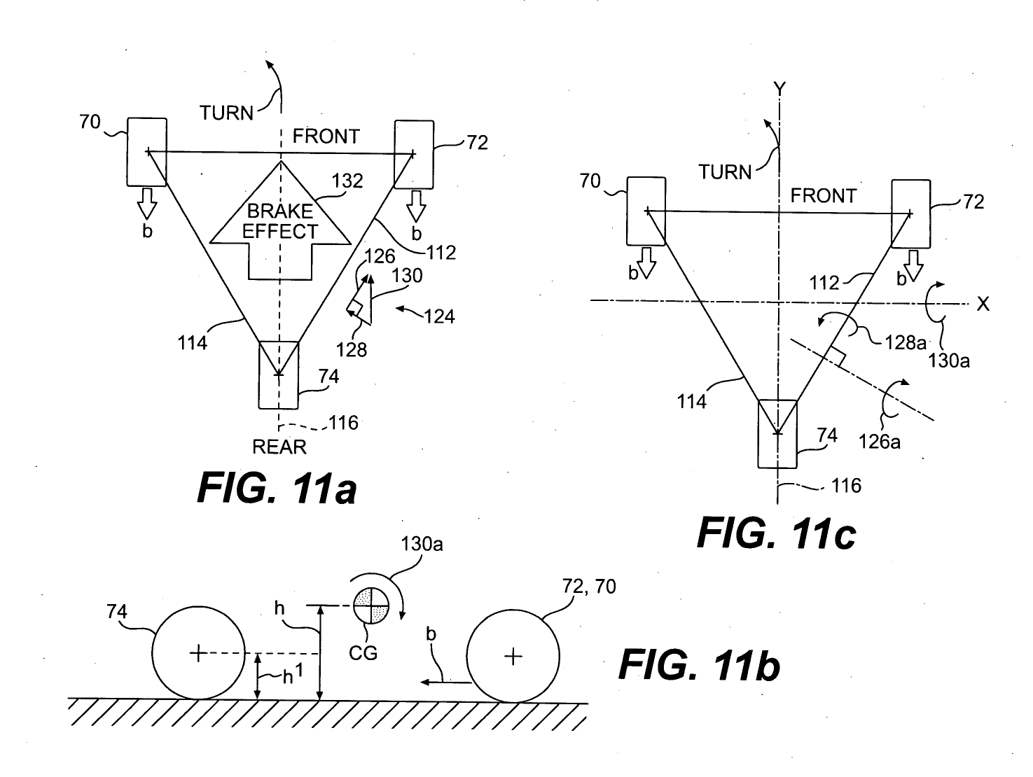

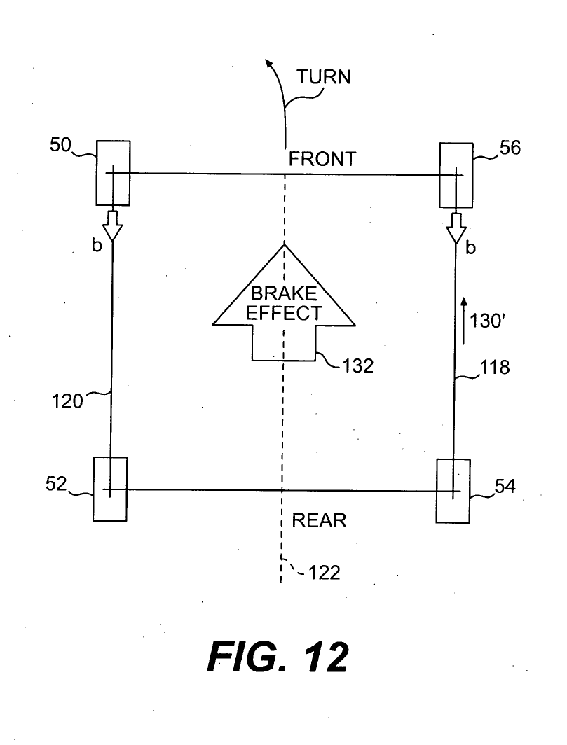

One feature of a three-wheeled vehicle 10 that differs from a four-wheeled vehicle results from the triangular shape of the three-wheeled vehicle. In particular, the triangular shape establishes roll axes 112, 114 that are not parallel to the longitudinal axis 116 of the vehicle. FIG. 11a provides a schematic diagram of the roll axes 112, 114 for a three-wheeled vehicle 10. Referring to FIG. 12, the roll axes 118, 120 for a four wheeled vehicle are parallel to the longitudinal axis 122 of the vehicle.

Since the roll axes 112, 114 for a three-wheeled vehicle 10 are not parallel to the longitudinal centerline 116 of the vehicle, if a braking force b is established by one of the two front tire footprints 70, 72 while the vehicle 10 is turning, the braking force b will have an effect on the vehicle that is explained by the vectorial diagram 124 in FIG. 11a. As shown, the braking force b will have a first force component 126 that is parallel to the roll axis 112 and a second force component 128 that is perpendicular to the first force component 126. The second force component 128, tends to counteract the tendency for the vehicle to roll over. Referring to FIG. 11b, resultant force 130 of FIG. 11a applied to the lever h (distance between the ground and the CG) generates a torque 130a around the X axis passing through the vehicle's CG. This has the effect to add more weight on the front wheels thus making them harder to lift form the ground. The second force component 128 creates a torque 128a over roll over axis 112 as depicted on FIG. 11c. Torque 128a has a corrective effect on the vehicle 10 because it acts on the vehicle 10 in against the roll over moment generated by the vehicle while cornering. The torque component 128a, therefore, assists the vehicle 10 to turn in the direction indicated in FIG. 11. The other resultant force 126 generates torque 126a thus adding weight on the front wheels. This corrective effect is not established for a four-wheeled vehicle because the roll axes 118, 120 are parallel to the longitudinal centerline 122 of the vehicle. The third force component 130 is the vectorial result of the first and second force components 126, 128. It is the same as the brake effect on the vehicle.

In FIG. 12, the vectorial component 132 of the brake effect is illustrated for a four-wheeled vehicle so that the vectorial differences between three-wheeled vehicles and four-wheeled vehicles may be more readily identified. Since a four-wheeled vehicle has a roll axis that is parallel to the longitudinal axis, when a braking force b is applied, the only effect generated thereby is the braking effect 132.

One main aspect of the present invention is to connect an ESS to a plurality of sensors for determining the operating conditions of the vehicle. When the operating conditions of the vehicle are extending over a predetermined operating limit the ESS automatically or semi-automatically acts on the braking system to generate an anti-roll over torque. The ESS can also act on the engine's operating conditions, the suspension operating conditions or any other vehicle parameters.

In one embodiment of the vehicle of the present invention, the suspension assembly, from which the front and rear wheels are suspended, may be adjusted by the ESS. In particular, the height of the vehicle may be modified, thus, influencing the vehicle's behavior. So configured, the suspension may be managed by the ESS to permit the vehicle to operate in an asymmetrical configuration. In other words, the suspension on one side of the vehicle (or the front end of the vehicle, or only one wheel) may be altered to improve the vehicle's behavior.

In connection with this embodiment of the vehicle of the invention, as illustrated in FIGS. 9a and 10, it is contemplated that force sensors 134, 136, 138 positioned on the shock mounts and/or the rear suspension may be constructed to measure the static distance between the CG of the vehicle and the ground. This information may be provided to the ESS so that further control over the vehicle may be asserted by the ESS.

As illustrated in FIGS. 9a and 10, the vehicle 10′ may include an engine torque sensor 140 (or a device that calculates engine torque based on input(s) from other sensor(s)). The ESS may control a traction control device 142, operatively connected to the engine 14, to control the amount of traction generated by the engine 14. In particular, the ESS may control the traction control device 142 to reduce the torque supplied by the engine 14 during operation. The effect of reducing the torque supplied by the engine 14 is the same as the effect of increasing the braking force applied to one or more the wheels.

Where a traction control device 142 is provided on the vehicle 10′, the traction control device 142 will control the traction applied to the rear wheel. In another contemplated embodiment, the engine 14 may be operatively connected to all three of the Wheels. In this embodiment, the traction control device 142 may reduce the torque supplied to one or more of the wheels on the vehicle 10′, thereby controlling the braking yaw movement Y_{b} of the vehicle 10′. Accordingly, where a traction control device 142 is provided, the braking yaw movement Y_{b} is affected both by the braking system and the traction control device. The brake pressure can be monitored thus generates another potential input for the ESS.

As also shown in FIGS. 9a and 10, it is contemplated that the ESS may receive input from an engine speed sensor 144 (sensing engine RPM, for example), an ignition timing sensor 146, an engine torque sensor 148, a throttle body sensor 148 (sensing the extent to which the throttle body is open, among other factors), and a fuel/air ratio sensor 150. Each of these inputs may provide information to the ESS so that the ESS may provide control signals to operational parameters of the engine 14 and the vehicle 10′ as a whole.

As discussed above, it is contemplated that the vehicle may include a GPS sensor (vehicle speed sensor 108) that provides information about the speed and travel direction of the vehicle. In one embodiment, the GPS sensor 108 may be a single sensor positioned at a suitable location on the vehicle 10′. In an alternate embodiment, several GPS sensors 108 may be positioned on disparate areas of the vehicle 10′ so that signals from the different sensors may be compared to one another to establish the yaw movement Yᵥ of the vehicle. By correlating data received from several GPS sensors 108 on the same vehicle 10′, it may be possible to provide more detailed control for the vehicle than is possible by relying on only a single GPS sensor 108. In still another embodiment, it is contemplated that a GPS sensor 108 may be placed on the rider (not shown), for example on the rider's helmet. With a GPS sensor 108 on the rider, the direction and position of the vehicle and the rider may be compared to provide still finer control over the vehicle 10′ and rider. Preferably, where a GPS sensor 108 is positioned on the rider, the GPS sensor 108 is wirelessly connected to the ECU 110. Of course, as would be appreciated by those skilled in the art, a wired connection also may be employed.

While the invention has been described in connection with what is presently considered to be the most practical and preferred embodiments, it is to be understood that the invention is not to be limited to the disclosed embodiments and elements, but, to the contrary, is intended to cover various modifications, combinations of features, equivalent arrangements, and equivalent elements included within the spirit and scope of the appended claims. Furthermore, the dimensions of features of various components that may appear on the drawings are not meant to be limiting, and the size of the components therein can vary from the size that may be portrayed in the figures herein. Thus, it is intended that the present invention covers the modifications and variations of the invention, provided they come within the scope of the appended claims and their equivalents.

### APPENDIX

http://www.rqriley.com/3-wheel.html

[image]

[image]

[image]

[image]

What is claimed is:

1. A three-wheeled vehicle, comprising:
a frame having a front portion, a rear portion, and a longitudinal axis;
an engine supported by the frame;
a front suspension connected to the front portion of the frame;
two front wheels supported by the front suspension and laterally spaced from one another, each wheel having a tire mounted thereon that is suitable for road use having a pressure of between 138 kPa and 345 kPa;
a rear suspension connected to the rear portion of the frame;
one rear wheel supported by the rear suspension and operatively connected to the engine, the wheel having a tire mounted thereon that is suitable for road use having a pressure of between 138 kPa and 345 kPa and being centered with respect to the longitudinal axis of the vehicle;
a braking system operatively connected to the wheels, the braking system including a brake and a brake actuator;
a steering assembly supported by the frame and operatively connected to at least one of the front wheels to transmit steering signals from an operator thereto;
a straddle seat supported by the frame; and
an electronic stability control system operatively connected to the braking system to supplement control of the vehicle based on sensed signals representative of operating conditions of the vehicle.

2. The three-wheeled vehicle of claim 1, wherein the electronic stability control system comprises:
an electronic control unit;
a vehicle speed sensor electronically connected to the electronic control unit;
a vehicle lateral acceleration sensor electronically connected to the electronic control unit; and
a vehicle yaw rate sensor electronically connected to the electronic control unit;
wherein the electronic control unit is operatively connected to the braking system and generates a control output signal to the braking system based on input from the vehicle speed sensor, the vehicle lateral acceleration sensor and the vehicle yaw rate sensor.

3. The three-wheeled vehicle of claim 2, further comprising a roll rate sensor.

4. The three-wheeled vehicle of claim 1, further comprising at least one element selected from the group consisting of:
an electronic control unit;
an engine torque sensor electronically connected to the electronic control unit;
an engine speed sensor electronically connected to the electronic control unit;
an ignition timing sensor electronically connected to the electronic control unit;
a throttle body sensor electronically connected to the electronic control unit; and
a fuel/air sensor electronically connected to the electronic control unit,
wherein the electronic control unit is operatively connected to the electronic stability control system and generates a control output signal to the braking system based on input from the selected element.

5. The three-wheeled vehicle of claim 2, wherein the straddle seat comprises:
a front portion for accommodating a driver and a rear portion for accommodating a passenger.

6. The three-wheeled vehicle of claim 5, further comprising:
a sensor electronically connected to the electronic control unit,
wherein the sensor is selected from a group of sensors comprising a steering angle sensor, a longitudinal accelerator sensor, a passenger detection sensor and a pitch rate sensor.

7. The three-wheeled vehicle of claim 2, wherein the electronic control unit generates a signal to influence the braking system to control a force vector for a selected tire, wherein the tire force vector creates a yaw moment on the vehicle.

8. The three-wheeled vehicle of claim 4, wherein the electronic control unit generates a signal to influence the braking device to control a force vector for a selected tire, wherein the tire force vector creates a yaw movement on the vehicle.

9. The three-wheeled vehicle of claim 7, wherein the electronic control unit also generates a signal to influence the braking device to control a force vector for a selected tire, wherein the tire force vector creates a yaw movement on the vehicle.

10. The three-wheeled vehicle of claim 2, further comprising:
a damping system coupled between at least one wheel and the frame, the stability control system controlling at least one of the front suspension system, the rear suspension system, and the damping system.

11. A method of controlling yaw stability of a vehicle with a longitudinal axis, a pair of front wheels disposed on either side of the longitudinal axis, a single rear wheel aligned with the longitudinal axis and a braking system associated with the wheels, comprising:
determining a yaw rate for the vehicle;
determining a lateral acceleration for the vehicle;
determining the vehicle speed; and
actuating the braking system on a maximum of the three wheels in response to at least one of the yaw rate, the lateral acceleration, and the vehicle speed so that a net moment on the vehicle opposes an induced yaw direction of the vehicle.

12. The method of controlling yaw stability of a three-wheeled vehicle of claim 11, further comprising:
determining the speed of the vehicle based on input from each front wheel and the rear wheel.

13. The method of controlling yaw stability of a three-wheeled vehicle of claim 11, further comprising:
changing power output of an engine based on at least one of the yaw rate, the lateral acceleration, and the vehicle speed.

14. The method of controlling yaw stability of a three-wheeled vehicle of claim 11, further comprising:
changing the power output of an engine.

15. The method of determining yaw stability of a three-wheeled vehicle of claim 11, wherein determining the vehicle speed is based on a rotatable sensor that contacts the ground.

16. The method of determining yaw stability of a three-wheeled vehicle of claim 11, wherein determining the vehicle speed is based on an optical sensor that evaluates relative speed between the vehicle and the ground.

17. A three-wheeled vehicle, comprising:
a frame having a front portion, a rear portion, and a longitudinal axis;
an engine supported by the frame;
a front suspension connected to the front portion of the frame;
two front wheels supported by the frame and laterally spaced from one another, the front wheels having tires suitable for road use having a pressure of between 138 kPa and 345 kPa;
a rear suspension connected to the rear portion of the frame;
one rear wheel supported by the frame and operatively connected to the engine, the rear wheel having a tire suitable for road use having a pressure of between 138 kPa and 345 kPa and being centered with respect to the longitudinal axis;
a braking system operatively connected to the wheels, the braking system including a brake and a brake actuator;
a steering assembly connected to the frame and at least one of the wheels that transmits steering signals thereto;
a straddle seat supported by the frame; and
an electronic stability control system connected to the braking system, wherein the electronic stability control system controls a vehicle operating parameter when steered outside of a predetermined range of variables, wherein the electronic stability system comprises
an electronic control unit;
a vehicle speed sensor electronically connected with the electronic control unit;
a vehicle lateral acceleration sensor electronically connected with the electronic control unit; and
a vehicle yaw rate sensor electronically connected with the electronic control unit;
wherein the electronic control unit is operatively connected to the braking system and actuates either the braking system based on input from signals from at least one of the vehicle speed sensor, the vehicle lateral acceleration sensor and the vehicle yaw rate sensor.

18. The three-wheeled vehicle of claim 17, wherein the electronic stability control system permits a front wheel to lift from the ground during lateral acceleration of the vehicle before actuating the braking system.

19. A three-wheeled vehicle, comprising:
a frame having a front portion, a rear portion having a longitudinal axis;
an engine supported by the frame;
a front suspension connected to the front portion of the frame;
first and second front wheels supported by the front suspension and laterally spaced from one another, each wheel having a tire mounted thereon that is suitable for road use having a pressure of between 138 kPa and 345 kPa;
a rear suspension connected to the rear portion of the frame;
one rear wheel supported by the rear suspension and operatively connected to the engine, the wheel having a tire mounted thereon that is suitable for road use having a pressure of between 138 kPa and 345 kPa and being centered with respect to the longitudinal axis of the vehicle;
a braking system operatively connected to the wheels, the braking system including a brake and a brake actuator;
a steering assembly supported by the frame and operatively connected to at least one of the wheels to transmit steering signals from an operator thereto;
a straddle seat supported by the frame; and
an electronic stability control system operatively connected to the braking system to supplement control of the vehicle based on sensed signals representative of operating conditions of the vehicle,
wherein the first front wheel establishes a rollover axis with the rear wheel and the second front wheel establishes a second rollover axis with the rear wheel, and
wherein, when the electronic stability system activates the braking system device, the braking device causes one of either of the first and second front wheels to brake, a force is established that is perpendicular to one of either the first and second rollover axes.

20. A three-wheeled vehicle, comprising:
a frame having a front portion, a rear portion and a longitudinal axis;
an engine supported by the frame;
a front suspension connected to the front portion of the frame;
first and second front wheels supported by the front suspension and laterally spaced from one another, each wheel having a tire mounted thereon that is suitable for road use having a pressure of between 138 kPa and 345 kPa;
a rear suspension connected to the rear portion of the frame;
one rear wheel supported by the rear suspension and operatively connected to the engine, the wheel having a tire mounted thereon that is suitable for road use having a pressure of between 138 kPa and 345 kPa and being centered with respect to the longitudinal axis;
a braking system operatively connected to the wheels, the braking system including a brake and a brake actuator;
a steering assembly supported by the frame and operatively connected to at least one of the wheels to transmit steering signals from an operator thereto;
a straddle seat supported by the frame; and
an electronic stability control system operatively connected to the braking system to supplement control of the vehicle based on a roll rate representative of operating conditions of the vehicle,
wherein the roll rate is based on the rotational speed difference between the front wheels.

21. The three-wheeled vehicle of claim 20, wherein the braking system applies a resistance to the rotation of the wheels to increase the rotational speed difference when one of the wheels has no contact with the ground.
